(19) United States
(12) Patent Application Publication
(10) Pub. No.: US 2012/0050693 A1
(43) Pub. Date: Mar. 1, 2012

(54) PROJECTOR

(75) Inventor: Hiroaki Yanai, Matsumoto-shi (JP)

(73) Assignee: SEIKO EPSON CORPORATION, Tokyo (JP)

(21) Appl. No.: 13/213,495

(22) Filed: Aug. 19, 2011

(30) Foreign Application Priority Data
Aug. 27, 2010 (JP) 2010-191076

(51) Int. Cl. G03B 21/14

(52) U.S. Cl. 353/31

(57) ABSTRACT

A projector according to an embodiment of the invention includes a first light source adapted to emit a light including a first colored light, a second light source adapted to emit a light including a second colored light and a third colored light, a color separation section to which the lights emitted from the respective light sources are input, and adapted to separate the incident lights into a first colored light, a second colored light, and a third colored light, liquid crystal light valves (first through third light modulation elements), and a relay optical system (a light transmission section) including a plurality of optical elements disposed between the color separation section and the first light modulation element.

### BACKGROUND

1. Technical Field

The present invention relates to a projector.

2. Related Art

A projector provided with a color separation optical system for separating light from a light source into three colors of colored lights, a display optical system having three light modulation devices corresponding respectively to the colored lights, and color combining optical system for combining the lights modulated by the respective light modulation devices is disclosed in the specification of U.S. Pat. No. 4,943,154. In this projector, it is arranged that the reduction of the light intensity and the initial color variation are prevented by setting the light path lengths (the distances from the light source to the light modulation devices) of the three colors of colored lights in the color separation optical system equivalent to each other. Specifically, in this projector, the light path lengths of the respective colored lights are made optically equivalent by making a light transmission optical system composed of relay lenses, field lenses, mirrors, and so on intervene in the light path of the colored light having the longest light path length. Thus, downsizing of the projector can be realized compared to the optical system making the light path lengths of all of the colored lights physically equal to each other.

However, there arises a problem that the shift in the illumination due to the temporal change such as the displacement of the light emitting point of the light source is different between the colors. This is because the shift in the illumination due to the displacement of the light source occurs on the screen in opposite directions depending on presence or absence of the light transmission optical system.

### SUMMARY

An advantage of some aspects of the invention is to provide a projector adopting an illumination device including a plurality of light sources and optimally arranging the light paths of the three colors of colored lights to thereby make it possible to reduce the color shading on the projection image, which is caused by the temporal change and so on, as much as possible.

A first aspect of the invention is directed to a projector including a first light source adapted to emit a light including a first colored light, a second light source adapted to emit a light including a second colored light and a third colored light, a color separation section to which the light emitted from the first light source and the light emitted from the second light source are input, the color separation section separating a light input into the first colored light, the second colored light, and the third colored light, a first light modulation element adapted to modulate the first colored light, a second light modulation element adapted to modulate the second colored light, a third light modulation element adapted to modulate the third colored light, a light transmission section including a plurality of optical elements disposed between the color separation section and the first light modulation element, a color combining section adapted to combine the first colored light modulated by the first light modulation element,the second colored light modulated by the second light modulation element, and the third colored light modulated by the third light modulation element, and a projection section adapted to project the light combined by the color combining section on a projection target surface.

In a conventional projector, there is a case in which a light transmission section including a plurality of optical components such as a relay lens or a field lens is made to intervene in the light path of the colored light having the longest physical light path length in order for making the light path lengths of the respective colored lights physically different from each other be optically equivalent to each other as described above. Here, the inventors have found out the fact that the problem that the color shading on the projection screen increases is caused by the following factors. In the case, for example, of using the three colors of colored lights, namely the red light (R), the green light (G), and the blue light (B), it results that the optical image of one of the colored lights having the light transmission section including a plurality of optical components intervene in the light path is flipped with respect to the optical images of two of the colored lights having the equivalent physical light path lengths each other due to the difference in the number of times of imaging. Therefore, if the displacement of the light emitting point of the light source occurs due to, for example, the temporal change, the direction of the displacement of the optical image is reversed between the colored light having the light transmission section intervene in the light path and the other two colored lights. As a result, there arises the problem that the color shading in the projection image increases. In other words, in the case of assigning the two colored lights obtained by separating the light emitted from the same light source respectively to the light path in which the light transmission section intervenes and the light path in which the light transmission section does not intervene, there arises the problem that the color shading in the projection image increases.

In contrast thereto, in the projector according to this aspect of the invention, there is adopted the configuration in which the light transmission section including a plurality of optical components is made to intervene in the light path of the first colored light emitted from the first light source, while no light transmission section is provided in the light paths of the second and third colored lights generated by separating the light emitted from the second light source. Thus, even if the displacement of the light emitting point occurs in the first light source or the second light source, it results only in the one-way displacement of the optical images, and there is no chance that the optical images overlapped with each other are displaced in the respective directions opposite to each other to thereby double the displacement amount. As described above, according to the projector of this aspect of the invention, even in the case of adopting the illumination system including the first light source and the second light source, the color shading on the projection image can be reduced as much as possible. It should be noted that the problem, and the actions and the advantages of the invention described above are difficult to explain only in writing, and will therefore be explained in detail in the “DESCRIPTION OF EXEMPLARY EMBODIMENTS” section with reference to the drawings.

In the projector according to the aspect of the invention, it is preferable to adopt the configuration in which a light distribution of the light emitted from the first light source is narrower than a light distribution of the light emitted from the second light source.

In general, since in the light path in which the light transmission section is inserted, the light path length is longer and the number of optical components (lenses) to be passed through is larger compared to the other light paths, vignetting of the light (the light is partially blocked due to the limitation in the coverage of the light of the optical component) becomes larger, and the light loss becomes larger compared to the case in which the light transmission section is not inserted. In this respect, according to the configuration described above, the light distribution of the light emitted from the first light source is narrower than the light distribution of the light emitted from the second light source, and the light from the first light source with narrower light distribution is assigned to the light path in which the light transmission section intervenes. Therefore, the overall light loss is reduced, and the light efficiency can be improved.

A second aspect of the invention is directed to a projector including a first light source adapted to emit a light including a first colored light, a second light source adapted to emit a light including a second colored light and a third colored light, a color separation section to which the light emitted from the first light source and the light emitted from the second light source are input, the color separation section separating a light input into the first colored light, the second colored light, and the third colored light; a first light modulation element adapted to modulate the first colored light, a second light modulation element adapted to modulate the second colored light, a third light modulation element adapted to modulate the third colored light, a first light transmission section including a plurality of optical elements disposed between the color separation section and the second light modulation element, a second light transmission section including a plurality of optical elements disposed between the color separation section and the third light modulation element, a color combining section adapted to combine the first colored light modulated by the first light modulation element, the second colored light modulated by the second light modulation element, and the third colored light modulated by the third light modulation element, and a projection section adapted to project the light combined by the color combining section on a projection target surface.

The projector according to the second aspect of the invention is obtained by making the light transmission sections intervene in two light paths out of the three light paths of the respective colored lights unlike the first projector of the invention. Therefore, in the second projector according to this aspect of the invention, in contrast to the first projector of the invention, there is adopted the configuration in which the light transmission section including a plurality of optical components is made to intervene in the light paths of the second and third colored lights generated by separating the light emitted from the second light source, while the light transmission section is not provided in the light path of the first colored light emitted from the first light source. Thus, even if the displacement of the light emitting point occurs in the first light source or the second light source, it results only in the one-way displacement of the optical images, and there is no chance that the optical images overlapped with each other are displaced in the respective directions opposite to each other to thereby double the displacement amount. As described above, according to the projector of this aspect of the invention, even in the case of adopting the illumination system including the first light source and the second light source, the color shading on the projection image can be reduced as much as possible.

In the projector according to the aspect of the invention, it is preferable to adopt the configuration in which the first light source is a laser source, and the second light source is a phosphor adapted to emit the light including the second colored light and the third colored light using the light including the first colored light emitted from the laser source as an excitation light.

According to this configuration, since the laser source is used as the first light source, it is possible to realize the projector, which is superior in the response of the light source such that the instant lighting is possible, and is capable of obtaining the projection image with high chromatic purity. Further, there is no need for separately preparing the light source for emitting the excitation light of the phosphor, and therefore, the configuration of the illumination system can be simplified.

In the projector according to the aspect of the invention, it is preferable to adopt the configuration in which the light emitted from the first light source and including the first colored light is a blue light, the light emitted from the second light source and including the second colored light and the third colored light is a yellow light, and the phosphor transmits a part of the blue light emitted from the first light source.

According to this configuration, since the blue laser source is used, the white light can be obtained with high efficiency, and therefore, the highly efficient projector can be realized.

In the projector according to the aspect of the invention, it is preferable to adopt the configuration in which the phosphor is formed of a phosphor layer formed on one surface of a plate member arranged to be rotatable.

According to this configuration, since the overheating of the phosphor layer can be prevented by rotating the plate member having the phosphor layer formed on one surface thereof while irradiating the phosphor layer with the laser beam, deterioration of the phosphor layer and the degradation of the emission efficiency can be prevented. Therefore, the projector superior in reliability can be realized.

### BRIEF DESCRIPTION OF THE DRAWINGS

The invention will be described with reference to the accompanying drawings, wherein like numbers reference like elements.

FIG. 1 is a schematic configuration diagram of a projector according to a first embodiment of the invention.

FIG. 2 is a diagram for explaining the operation of a relay optical system.

FIG. 3 is a diagram for explaining the operation of an optical system except the relay optical system.

FIGS. 4A and 4B are diagrams for explaining an operation and an advantage of the projector.

FIG. 5 is a schematic configuration diagram of a projector according to a second embodiment of the invention.

FIG. 6 is a schematic configuration diagram of a projector according to a third embodiment of the invention.

FIG. 7 is a schematic configuration diagram of a projector according to a fourth embodiment of the invention.

### DESCRIPTION OF EXEMPLARY EMBODIMENTS

### First Embodiment

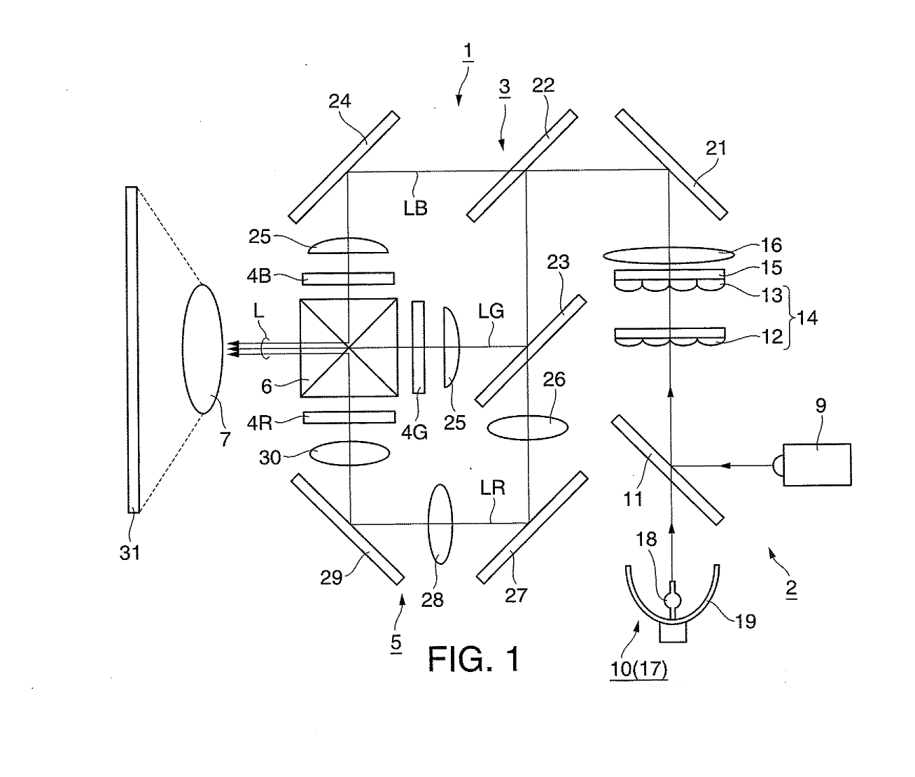

Hereinafter, a first embodiment of the invention will be explained with reference to FIGS. 1 through 3, 4A, and 4B.

The projector according to the present embodiment is a projector provided with liquid crystal light valves respectively modulating the three colors of colored lights, red (R) light, green (G) light, and blue (B) light, namely a so-called three-panel liquid crystal projector. Further, in the present embodiment, a configuration of inserting a relay optical system in the light path of the red light out of the three colors of colored lights will be explained as an example.

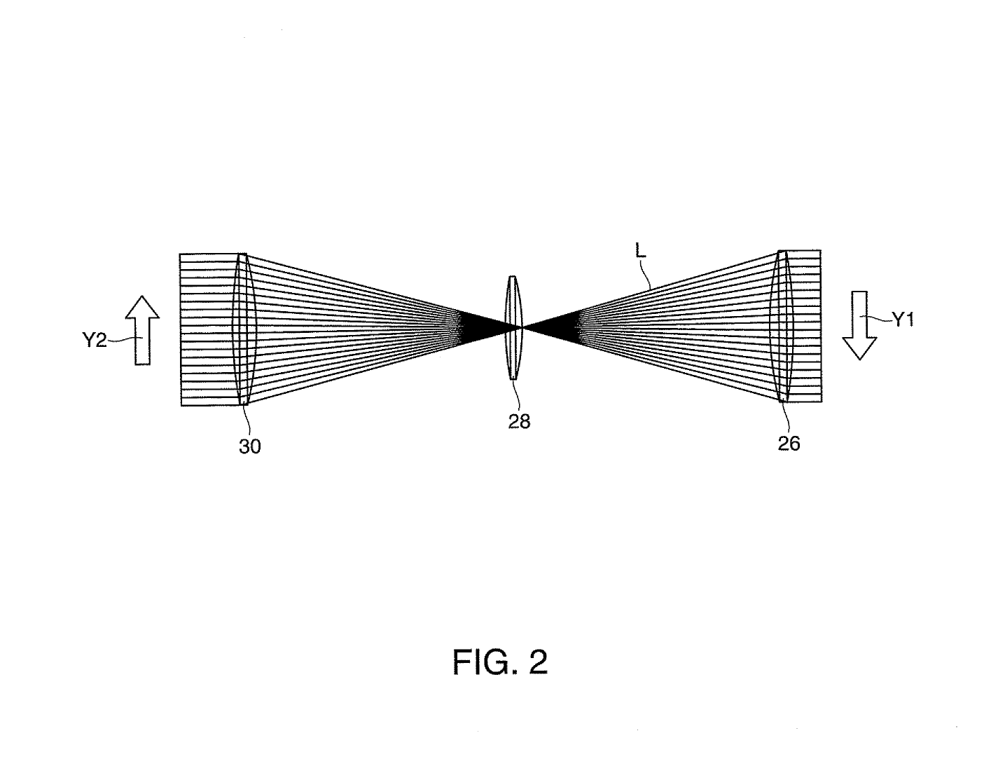

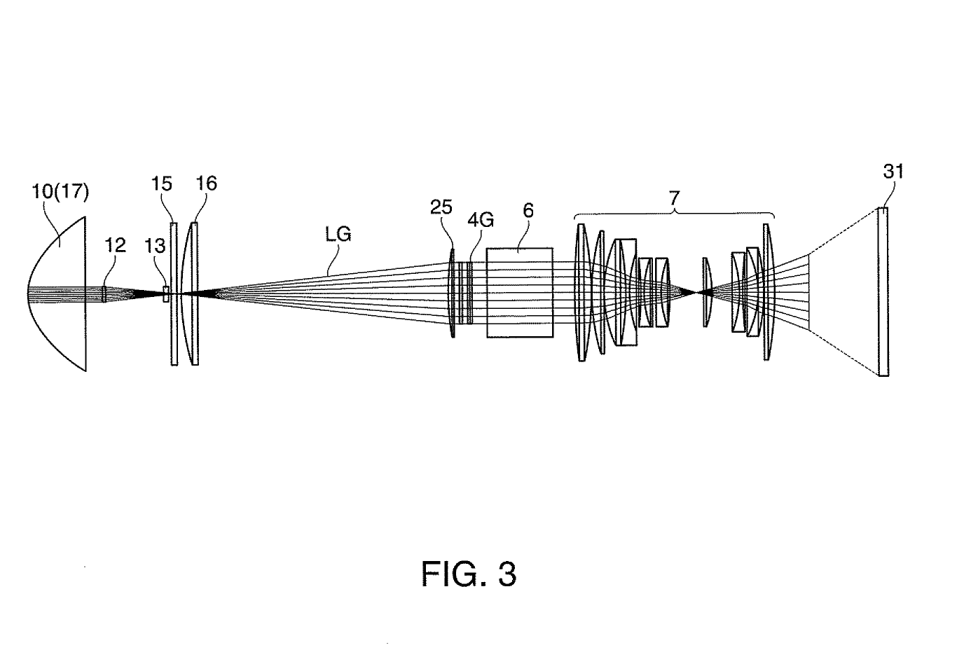

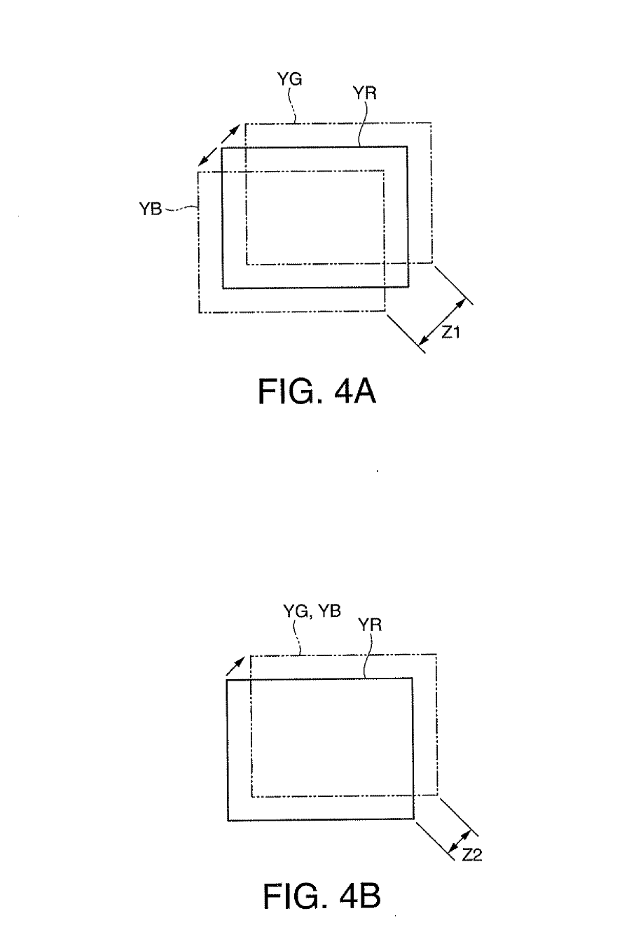

FIG. 1 is a schematic configuration diagram of the projector according to the present embodiment. FIG. 2 is a diagram for explaining the operation of the relay optical system. FIG. 3 is a diagram for explaining the operation of an optical system except the relay optical system. FIGS. 4A and 4B are diagrams for explaining an operation and an advantage of the projector.

It should be noted that in the following drawings, the constituents might be shown with the scale ratios of respective sizes set differently between the constituents in order for facilitating the visualization of each of the constituents.

As shown in FIG. 1, the projector 1 according to the present embodiment is mainly composed of an illumination section 2, a color separation section 3, liquid crystal light valves 4R, 4G, and 48 (light modulation elements), a relay optical system 5 (a light transmission section), a cross dichroic prism 6 (a color combining section), a projection lens 7 (a projection section), and so on. It should be noted that although the projection lens 7 is shown with one lens alone in FIG. 1 in order for making the drawing simple, the projection lens 7 is composed of a plurality of lenses in reality.

The illumination section 2 of the present embodiment is provided with a first light source 9, a second light source 10, a dichroic mirror 11, a pair of lens arrays 14 composed of a first lens array 12 and a second lens array 13, a polarization conversion element 15, and an overlapping lens 16. The first light source 9 is a red solid-state light source for emitting the red light. As the red solid-state light source, it is possible to use a red light emitting diode (hereinafter abbreviated as LED), or to use a red laser source. The second light source 10 is a white lamp 17 such as a high-pressure mercury lamp or a metal halide lamp for emitting white (W) light. The white lamp 17 is composed of a light emitting tube 18 and a reflector 19 for reflecting the light from the light emitting tube 18 to thereby emit it forward. Therefore, the white light including the red light, the green light, and the blue light is emitted from the white lamp 17 as the second light source 10. Although the typical high-pressure mercury lamp tends to be short of the red light, by supplementing it with the red light from the red solid-state light source, the color can be improved.

The dichroic mirror 11 for combining the red light and the white light is disposed on the light path of both of the red light emitted from the first light source 9 and the white light emitted from the second light source 10. The dichroic mirror 11 is formed by, for example, stacking a dielectric multilayer film on a glass surface. Thus, the dichroic mirror 11 selectively reflects the colored light in a predetermined wavelength band, and selectively transmits the colored light in the other wavelength band. Specifically, the dichroic mirror 11 of the present embodiment has a property of reflecting the red light while transmitting the green light and the blue light.

Therefore, the red light emitted from the first light source 9 is reflected by the dichroic mirror 11 to thereby change the proceeding direction, and then proceeds toward the color separation section 3 in the next stage. Further, the green light and the blue light out of the white light emitted from the second light source 10 are transmitted through the dichroic mirror 11, and then proceed toward the color separation section 3 in the next stage. In such a manner as described above, the red light emitted from the first light source 9 and the green light and the blue light emitted from the second light source 10 are combined by the dichroic mirror 11 to thereby form the white light. In this configuration, since it results that the red light emitted from the red solid-state light source is used for display instead of the red light component included in the spectrum of the white light from the white lamp 17, by appropriately selecting the red solid-state light source, the red color with high chromatic purity, for example, can be expressed.

The pair of lens arrays 14 and the overlapping lens 16 are for equalizing the intensity distribution of the light emitted from each of the light sources 9, 10. The white light combined by the dichroic mirror 11 is divided by the pair of lens arrays 14 into a plurality of light beams, and then the plurality of light beams are overlapped by the overlapping lens 16 on the liquid crystal light valves 4R, 4G, and 4B as the illuminated areas, and thus the illuminance distribution of the light on each of the liquid crystal light valves 4R, 4G, and 4B is equalized. Further, the polarization conversion element 15 has a polarization beam splitter array (PBS array) and a half wave plate array, although the detailed structure thereof is not shown. Out of the light input from the pair of lens arrays 14 to the PBS array, the linearly polarized light with a first polarization direction is transmitted through the polarization beam splitting film (the PBS film) in the PBS array, and at the same time, the linearly polarized light with a second polarization direction is reflected by the PBS film in the PBS array. The polarized light thus reflected is changed in the polarization direction by the half wave plate array to the first polarization direction, and is then emitted. As described above, the polarization conversion element 15 has a function of aligning the polarization direction of the source light to one direction without losing the intensity of the source light.

The light transmitted through the overlapping lens 16 is reflected by the mirror 21, and then enters the color separation section 3. The color separation section 3 is provided with two dichroic mirrors 22, 23. Similarly to the dichroic mirror 11 of the illumination section 2, these dichroic mirrors 22, 23 are each formed by, for example, stacking a dielectric multilayer film on a glass surface, and selectively reflect the colored light in a predetermined wavelength band while selectively transmitting the colored light in the other wavelength band. Specifically, the dichroic mirror 22 transmits the blue light LB, while reflecting the red light LR and the green light LG. The dichroic mirror 23 transmits the red light LR while reflecting the green light LG out of the red light LR and the green light LG reflected by the dichroic mirror 22.

The blue light LB transmitted through the dichroic mirror 22 is reflected by the mirror 24, and then enters the liquid crystal light valve 4B for blue light via a field lens 25. The green light LG reflected by the dichroic mirror 23 enters the liquid crystal light valve 4G for the green light via the field lens 25.

The red light LR transmitted through the dichroic mirror 23 enters the liquid crystal light valve 4R for red light via the relay optical system 5. The relay optical system 5 is composed of a first relay lens 26, a mirror 27, a second relay lens 28, a mirror 29, and a third relay lens 30 disposed in this order from the dichroic mirror 23 side. The third relay lens 30 functions also as a field lens in an anterior stage of the liquid crystal light valve for the red light. In the case of the present embodiment, since the light path length of the red light LR is longer than the light path lengths of the other colored lights LG, LB, such a relay optical system 5 is disposed on the light path of the red light LR in order for reducing the light loss due to the long light path. The relay optical system 5 has an effect of making the illumination area adjacent to the first relay lens 26 and the illumination area adjacent to the third relay lens 30 approximately equal to each other. Therefore, the loss due to the expansion of the illumination area and the ununiformity (unevenness) in the illumination due to the displacement of imaging can be reduced compared to the case in which the relay optical system 5 is not used. The ununiformity (unevenness) in the illumination causes the initial color shading, and is therefore undesirable.

Each of the liquid crystal light valves 4R, 4G, and 4B is composed of a transmissive liquid crystal cell, and polarization plates (they are not shown) disposed respectively on the entrance side and the exit side thereof. The transmissive liquid crystal cell is, for example, an active matrix liquid crystal cell, and has a liquid crystal layer sandwiched between a pair of electrodes. Further, the liquid crystal light valves 4R, 4G, and 4B are electrically connected to an arbitrary signal source for supplying an image signal. When the image signal is supplied from the signal source, a voltage is applied between the electrodes of the transmissive liquid crystal cell, and the orientation direction of the liquid crystal molecules is controlled in accordance with the applied voltage. Thus, it is arranged that the modulation of the incident light is possible. The red light LR, the green light LG, and the blue light LB modulated by the respective liquid crystal light valves 4R, 4G, and 4B enter the cross dichroic prism 6.

The cross dichroic prism 6 has a structure having triangular prisms bonded to each other, and a selectively reflecting surface (a dichroic surface) for reflecting the red light LR and transmitting the green light LG and the blue light LB, and a selectively reflecting surface (a dichroic surface) for reflecting the blue light LB and transmitting the red light LR and the green light LG are formed as the interior surfaces thereof so as to be perpendicular to each other. The red light LR and the blue light LB are selectively reflected by these selectively reflecting surfaces while the green light LG is selectively transmitted through these selectively reflecting surfaces, and thus the three colored lights are emitted toward the same side. Thus, the three colored lights are overlapped with each other to form a composite light L. The composite light L emitted from the cross dichroic prism 6 is projected by the projection lens 7 composed of a plurality of lenses on a screen 31 (a projection target surface) in an enlarged manner.

FIG. 2 is a diagram showing how the light L is focused in the configuration in which only the first relay lens 26, the second relay lens 28, and the third relay lens 30 are taken out from the constituents of the relay optical system 5 and developed linearly while the mirrors 27, 29 are omitted. As shown in the drawing, the optical image input to the first relay lens 26 is imaged as an intermediate image in the second relay lens 28, and then the intermediate image is enlarged by the second relay lens 28, and then transmitted to the third relay lens 30. In this process, the optical image Yl input to the first relay lens 26 turns to an optical image Y2 flipped vertically and horizontally at the position of the third relay lens 30.

FIG. 3 is a diagram showing a configuration of taking out the optical elements except the mirrors in the light path of the colored light (the green light LG is shown as a representative) in which the relay optical system 5 is not provided, and then developing them linearly to thereby show how the light LG is focused. Hereinafter, how the optical image is flipped in the light path in which the relay optical system 5 does not intervene will be explained using FIG. 3. It should be noted that it is assumed that the flip only in a horizontal direction caused when the light reflection occurs in the mirrors, the cross dichroic prism, and so on to thereby deflect the light path is not considered on this occasion, and the flip in both of vertical and horizontal directions will be considered.

The light LG emitted from the first lens array 12 is imaged on the surface of the liquid crystal light valve 4G as an image flipped vertically and horizontally via the second lens array 13, the polarization conversion element 15, the overlapping lens 16, and the field lens 25. Further, the light LG is imaged again on the screen 31 as an image flipped vertically and horizontally via the dichroic prism 6 and the projection lens 7. Therefore, the illumination image formed on the surface of the first lens array 12 is imaged on the screen 31 as it is without being flipped vertically and horizontally.

In contrast thereto, as is explained using FIG. 2, the flip in both of the vertical and horizontal directions is caused once by the relay optical system 5 in the light path of the colored light with the relay optical system 5 intervening between the second lens array 13 and the field lens 25. It should be noted that although the horizontal flip is caused by the mirror or the cross dichroic prism, the number of times of reflection (deflection of the light path) itself is different between the light paths, but whether the number of times of reflection is an even number or an odd number is the same between all of the light paths irrespective of the presence or absence of the relay optical system 5. In the case of the present embodiment, as shown in FIG. 1, the numbers of times of reflection of the respective colored lights between the second lens array 13 and the field lens 25 are three in the blue light, three in the green light, and five in the red light, which are all odd numbers. That is, taking only the horizontal flips into consideration, the result of the horizontal flips of the optical image is the same between the light path in which the relay optical system 5 intervenes and the light path in which the relay optical system 5 does not intervene. Therefore, as a whole, the number of flips in both of the vertical and horizontal directions of the optical image is larger by one in the light path in which the relay optical system 5 intervenes than the optical path in which the relay optical system 5 does not intervene.

The case in which the displacement of the second light source 10 or the shift in the light emitting point (arc) is caused by, for example, the temporal change is considered. It should be noted that it is assumed that the displacement or the shift in the light emitting point does not occur in the first light source 9. Since in the case of the present embodiment the red light LR is emitted from the first light source 9 formed of the red solid-state light source, and the green light LG and the blue light LB are emitted from the second light source 10 formed of the white lamp, it results that the optical images of the green light LG and the blue light LB are displaced from the original positions on the screen 31 due to the temporal change described above.

Here, if the relay optical system 5 is inserted in either one of the light path of the green light and the light path of the blue light unlike the configuration of the present embodiment, since the optical image YG (indicated by the dashed-dotted line) of the green light and the optical image YB (indicated by the dashed-dotted line) of the blue light are in a relationship of being flipped vertically and horizontally while the optical image YR (indicated by the solid line) of the red light is located at the original position on the screen 31 as shown in FIG. 4A, the displacement directions of the optical image YG of the green light and the optical image YB of the blue light become opposite to each other, and the displacement amount Z1 of the whole optical image becomes twice as large as the original displacement amount due to the displacement of the light source. In contrast thereto, in the case of inserting the relay optical system into the light path of the red light as in the configuration of the present embodiment, since the optical image YG of the green light and the optical image YB of the blue light are not in the flipped relationship, the displacement directions of the optical image YG (indicated by the dashed-dotted line) of the green light and the optical image YB (indicated by the dashed-dotted line) of the blue light coincide with each other, and the displacement amount 12 of the whole optical image is equal to the original displacement amount due to the displacement of the light source as shown in FIG. 4B.

As explained hereinabove, according to the projector 1 of the present embodiment, even in the configuration of adopting the illumination section 2 including the first light source 9 and the second light source 10, and the relay optical system 5, the color shading of the projection image due to the displacement of the light source and the shift in the light emitting point (arc) caused by the temporal change can be reduced as much as possible. Although in the explanation described above it is assumed that the displacement or the like is caused in the second light source 10, if the displacement or the shift in the light emitting point occurs in the first light source 9 for emitting the red light, there is no particular difference in the influence on the color shading no matter which light paths the relay optical system 5 is inserted in. However, in comparison between the first light source 9 using the solid-state light source and the second light source 10 using the super high-pressure mercury lamp or the like, the displacement of the light source, the shift in the light emitting point, and so on more easily occur in the second light source 10, and therefore, the configuration of the present embodiment is extremely advantageous from this point of view.

Further, in the case of the projector using a plurality of light sources, it is possible to adopt the configuration of disposing the plurality of light sources at positions distant from each other. However, by disposing the plurality of light sources at one place in a concentrated manner as in the present embodiment, a cooling mechanism for the light sources, an illumination integrating optical system composed of a pair of lens arrays, a polarization conversion optical system, and so on can be used in common.

### Second Embodiment

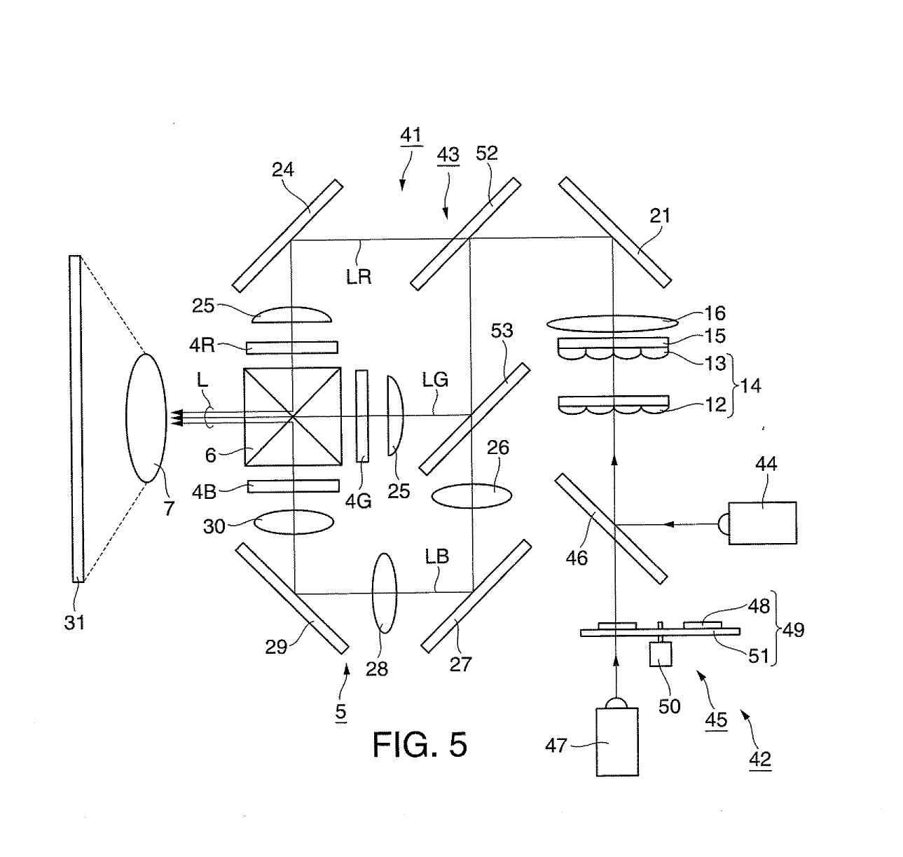

Hereinafter, a second embodiment of the invention will be explained with reference to FIG. 5.

The basic configuration of the projector according to the present embodiment is substantially the same as that of the first embodiment, and is different from that of the first embodiment in the configuration of the illumination section and in the point that the relay optical system is inserted in the light path of the blue light.

FIG. 5 is a schematic configuration diagram of the projector according to the present embodiment. In FIG. 5, the constituents common to FIG. 1 used in the first embodiment are denoted with the same reference symbols, and the explanation therefor will be omitted.

As shown in FIG. 5, the projector 41 according to the present embodiment is mainly composed of an illumination section 42, a color separation section 43, the liquid crystal light valves 4R, 4G, and 4B (the light modulation elements), the relay optical system 5 (the light transmission section), the cross dichroic prism 6 (the color combining section), the projection lens 7 (the projection section), and so on.

The illumination section 42 of the present embodiment is provided with a first light source 44, a second light source 45, and a dichroic mirror 46. The first light source 44 is a blue laser source for emitting the blue light. The second light source 45 is provided with an ultraviolet laser source 47 for emitting an ultraviolet light and a rotating fluorescent plate 49 provided with a phosphor layer 48. The rotating fluorescent plate 49 is composed of a plate member 51 arranged to be rotatable due to a drive source 50 such as an electric motor, and the phosphor layer 48 formed on one surface of the plate member 51. The phosphor layer 48 is for emitting a yellow light using the ultraviolet light as an excitation light. Therefore, when the ultraviolet light emitted from the ultraviolet laser source 47 is applied to the phosphor layer 48 of the rotating fluorescent plate 49, the ultraviolet light acts as the excitation light to thereby make the phosphor layer 48 emit the yellow light (the light including the red light and the green light).

The dichroic mirror 46 for reflecting the blue light and transmitting the yellow light to thereby combine the blue light and the yellow light is disposed on the light path of both of the blue light emitted from the first light source 44 and the yellow light emitted from the second light source 45. Thus, the blue light emitted from the first light source 44 and the yellow light emitted from the second light source 45 are combined by the dichroic mirror 46 to thereby form the white light. The illumination section 42 of the present embodiment has the first light source 44 and the second light source 45 each formed of a laser source, and is therefore superior in the response of the light source such that instant lighting is possible, and further the colored lights with high chromatic purity can be obtained. Further, regarding the green light and the red light, the highly efficient laser source corresponding to the required wavelength has not yet been obtained at present. Therefore, the three colored lights, namely the blue light, the green light, and the red light, can be obtained using the laser sources by adopting the configuration of the present embodiment although partially going through the fluorescence process.

The configuration of the color separation section 43 is substantially the same as that of the first embodiment in the point that two dichroic mirrors 52, 53 are used, but is different from that of the first embodiment in the spectral characteristics of each of the dichroic mirrors 52, 53. The dichroic mirror 52 transmits the red light LR, while reflecting the green light LG and the blue light LB. The dichroic mirror 53 transmits the blue light LB while reflecting the green light LG out of the green light LG and the blue light LB reflected by the dichroic mirror 52. In the case of the present embodiment, the physical light path length becomes the same between the light path of the red light LR and the light path of the green light LG, and the physical light path length of the light path of the blue light LB becomes larger compared thereto. Therefore, the relay optical system 5 is inserted in the light path of the blue light LB. The rest of the configuration is substantially the same as that of the first embodiment.

In the case of the present embodiment, the blue light LB is emitted from the first light source 44 formed of the blue laser source while the green light LG and the red light LR are emitted from the second light source 45 composed of the ultraviolet laser source 47 and the rotating fluorescent plate 49. Further, since the relay optical system 5 is inserted in the light path of the blue light LB, the optical image of the green light LG and the optical image of the red light LR are in a non-flipped relationship. Therefore, if the displacement of the second light source 45 or the shift in the light emitting point occurs, the displacement direction coincides between the optical image of the green light and the optical image of the red light, and there is no chance that the displacement amount of the whole optical image expands beyond the original displacement amount. As described above, also in the projector 41 according to the present embodiment, the advantage that the color shading of the projection image due to the displacement of the light source caused by the temporal change can be reduced, which is the same as that of the first embodiment, can be obtained.

### Third Embodiment

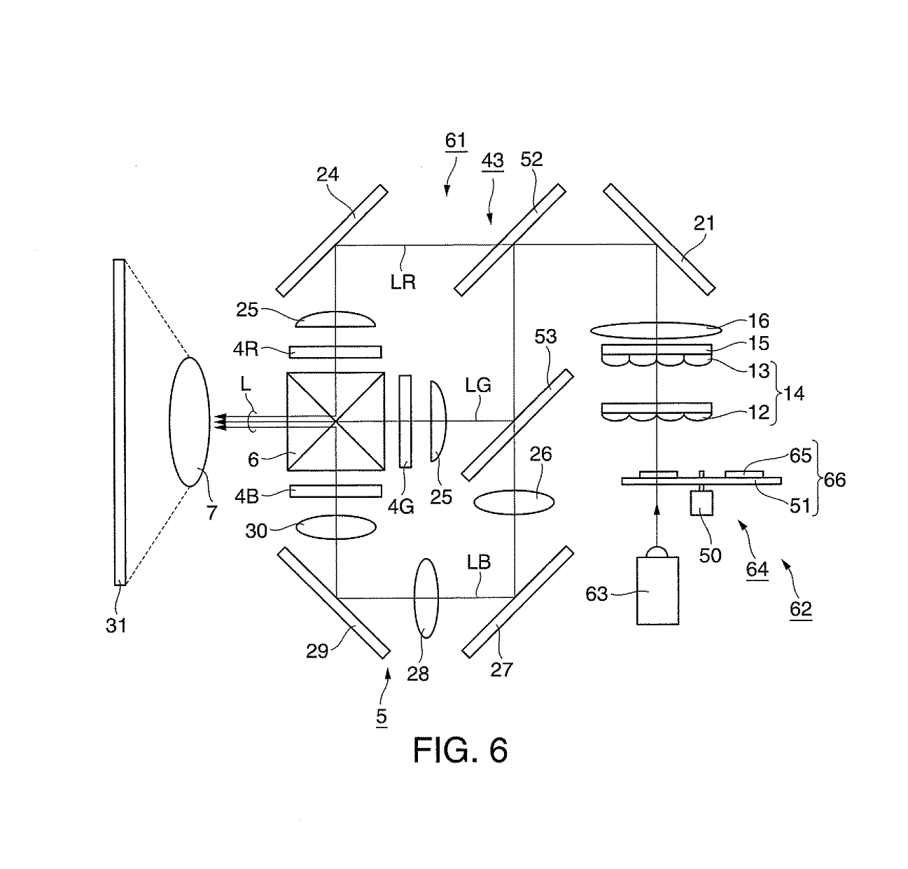

Hereinafter, a third embodiment of the invention will be explained with reference to FIG. 6.

The basic configuration of the projector according to the present embodiment is substantially the same as that of the first embodiment, but is different from that of the first embodiment in the configuration of the illumination section. Further, it is substantially the same as that of the second embodiment in the point that the relay optical system is inserted in the light path of the blue light.

FIG. 6 is a schematic configuration diagram of the projector according to the present embodiment. In FIG. 6, the constituents common to FIG. 1 used in the first embodiment are denoted with the same reference symbols, and the explanation therefor will be omitted.

As shown in FIG. 6, the projector 61 according to the present embodiment is mainly composed of an illumination section 62, the color separation section 43, the liquid crystal light valves 4R, 4G, and 4B (the light modulation elements), the relay optical system 5 (the light transmission section), the cross dichroic prism 6 (the color combining section), the projection lens 7 (the projection section), and so on.

The illumination section 62 of the present embodiment is provided with a first light source 63, and a second light source 64. In the present embodiment, the dichroic mirror 46 used in the second embodiment is unnecessary, and therefore, the configuration of the illumination section 62 is further simplified. The first light source is a blue laser source for emitting the blue light. The second light source 64 is a rotating fluorescent plate provided with a phosphor layer 65. The rotating fluorescent plate 66 is composed of the plate member 51 arranged to be rotatable due to the drive source 50 such as an electric motor, and the phosphor layer 65 formed on one surface of the plate member 51. The schematic configuration of the rotating fluorescent plate 66 is substantially the same as that of the second embodiment, but is different in the characteristics of the phosphor layer 65 from that of the second embodiment.

While the phosphor layer 48 of the second embodiment is for emitting the yellow light using the ultraviolet light as the excitation light, the phosphor layer 65 of the present embodiment is for emitting the yellow light using the blue light as the excitation light. Therefore, while in the second embodiment, the ultraviolet laser source 47 for emitting the ultraviolet light functioning only as the excitation light is separately required, the laser source for emitting the excitation light making no contribution to the display is unnecessary in the present embodiment. Specifically, in the present embodiment, a part of the blue light emitted from the blue laser source as the first light source 63 is used as the excitation light for the phosphor layer 65, and the rest thereof is used for the projection display. Therefore, the rotating fluorescent plate 66 has a function of transmitting the blue light. Therefore, when the phosphor layer 65 of the rotating fluorescent plate 66 is irradiated with the blue light emitted from the first light source 63, the part of the blue light acts as the excitation light to thereby make the phosphor layer 65 emit the yellow light (the light including the red light and the green light), and then the white light having the rest of the blue light and the yellow light combined with each other is emitted from the rotating fluorescent plate 66. The ratio between the blue light and the yellow light can be controlled by varying, for example, the thickness of the phosphor layer 65 or the concentration of the phosphor in the Phosphor layer 65. The rest of the configuration is substantially the same as that of the second embodiment.

Also in the projector 61 according to the present embodiment, the advantage that the color shading of the projection image due to the displacement of the light source caused by the temporal change can be reduced, which is the same as those of the first and second embodiments, can be obtained.

In both of the second and third embodiments, the rotating fluorescent plate 49, 66 is used as the second light source 45, 64. Therefore, it is possible that the rotational axis of the rotating fluorescent plate 49, 66 is tilted with respect to the optical axis or wobbling of the rotation occurs due to the temporal change. Here, the rotating fluorescent plate 49, 66 is a flat plate, even if the rotating fluorescent plate 49, 66 is tilted, the angle of the blue light emitted from the first light source 44, as the laser source is kept between the anterior position and the posterior position of the rotating fluorescent plate 49, 66. Meanwhile, since the emitting point of the yellow light emitted from the second light source 45, 64 is the phosphor disposed in the rotating fluorescent plate 49, 66, the yellow light is emitted from the surface of the rotating fluorescent plate 49, 66 with a Lambertian luminance distribution. Therefore, if the rotating fluorescent plate 49, 66 is tilted, the axis of the yellow light emitted from the second light source 45, is also tilted, and it results that the incident position in the posterior element is displaced. Therefore, even if the tilt of the rotating fluorescent plate 49, 66 or the wobbling of the rotation described above occurs, while only the minute parallel translation is caused in the optical axis of the light emitted from the first light source 44, 63, the light emitted from the second light source 45, 64 has an influence on the optical system in the posterior stage as a significant displacement of the light emitting point. From that point of view, the configuration of the present embodiment is extremely advantageous.

In general, in the light path having the relay optical system inserted therein, the light path length is longer and the number of lenses to be passed through is also larger compared to the other light paths, and therefore, the vignetting of the light increases to thereby increase the loss of the light compared to the light path in which the relay optical system is not inserted. Since it is required to ensure the coverage of the lens for reducing the vignetting of the light, it is desired to assign the light with the narrow light distribution to the light path in which the relay optical system is inserted. Here, while a laser source is high in directionality and has a sharp luminance distribution, a lamp such as a high-pressure mercury lamp or a phosphor hardly has directionality, and has a broad luminance distribution. In the configurations of the first through third embodiments, the light from the first light source 9, 44, 63 as the laser source is assigned to the light path in which the relay optical system 5 is inserted. Therefore, the overall light loss is reduced, and the light efficiency can be improved.

### Fourth Embodiment

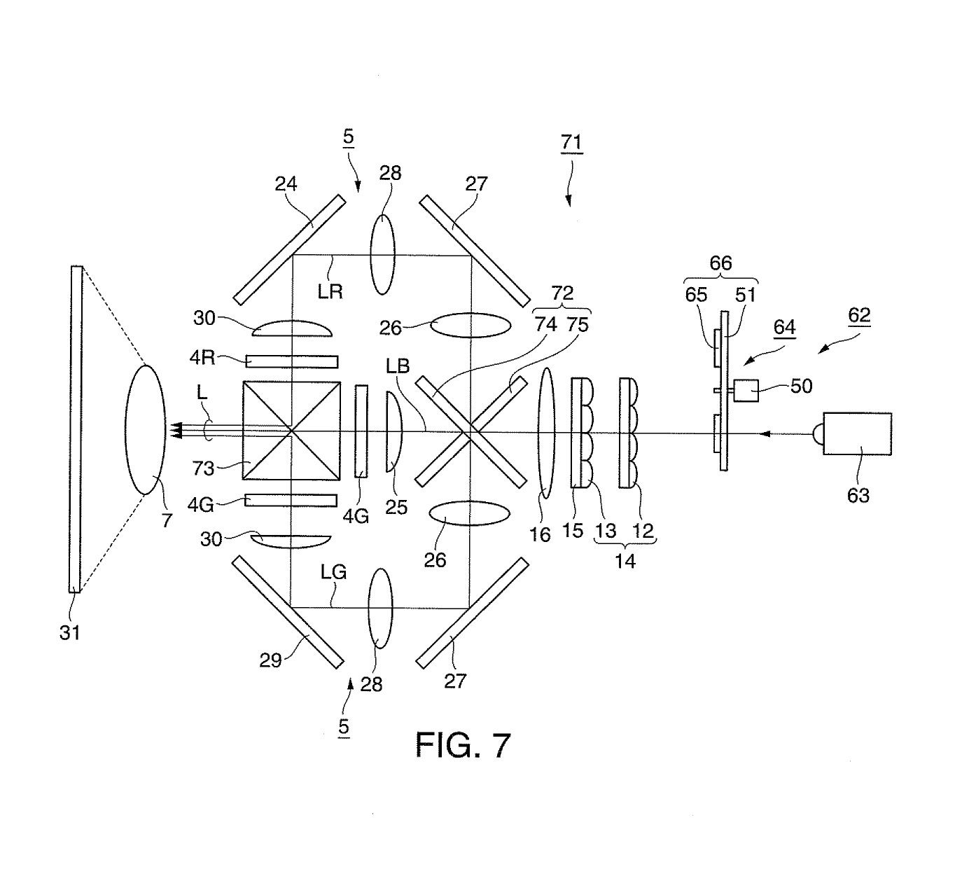

Hereinafter, a fourth embodiment of the invention will be explained with reference to FIG. 7.

The basic configuration of the projector according to the present embodiment is substantially the same as that of the first embodiment, and is different from those of the first through third embodiments in the point that the relay optical systems are inserted in two of the three light paths of the respective colored lights.

FIG. 7 is a schematic configuration diagram of the projector according to the present embodiment. In FIG. 7, the constituents common to FIG. 1 used in the first embodiment are denoted with the same reference symbols, and the explanation therefor will be omitted.

As shown in FIG. 7, the projector 71 according to the present embodiment is mainly composed of a color separation section composed of the illumination section 62 and a cross dichroic mirror 72, the liquid crystal light valves 4R, 4G, and 4B (the light modulation elements), a firstrelay optical system 5 (the light transmission section) for the red light, a second relay optical system (the light transmission section) for the green light, a cross dichroic prism 73 (a color combining section), the projection lens 7 (the projection section), and so on. The illumination section 62 has the first light source 63 formed of the blue laser source and the second light source 64 formed of the rotating fluorescent plate 66, and the configuration thereof is substantially the same as that of the third embodiment.

In the case of the present embodiment, the color separation section is formed of the cross dichroic mirror 72 composed of two dichroic mirrors 74,. 75. The dichroic mirror 74 has a property of transmitting the blue light LB while reflecting the green light LG and the red light LR. The dichroic mirror 75 has a property of transmitting the blue light LB, reflecting the green light LG, and transmitting the red light LR. According to the cross dichroic mirror 72 having these dichroic mirrors 74, 75 combined with each other, the configuration of transmitting the blue light LB, and reflecting the green light LG and the red light LR in the respective directions opposite to each other can be realized. Thus, the physical light path lengths of the green light LG and the red light LR become longer than the physical light path length of the blue light LB. Therefore, the first relay optical systems 5 for the red light LR is inserted in the light path of the red light LR, and the second relay optical systems 5 for the green light LG is inserted in the light path of the green light LG. The internal configuration of the relay optical system 5 is substantially the same as those of the first through third embodiments.

Further, the cross dichroic prism 73 (the color combining section) is formed to have two dichroic surfaces orthogonally crossing to each other, and the spectral characteristics of these dichroic surfaces are substantially the same as the spectral characteristics of the two dichroic mirrors 74, 75 of the cross dichroic mirror 72.

In the projector 71 according to the present embodiment, in contrast to the projector 61 according to the third embodiment, there is adopted the configuration in which the relay optical systems 5 are inserted in each of the light paths of the green light LG and the red light LR generated by separating the light emitted from the second light source 64, while the relay optical system 5 is not inserted in the light path of the blue light LB emitted from the first light source 63. Therefore, the optical image of the green light LG and the optical image of the red light LR generated from the second light source 64 are not in the flipped relationship. Thus, even if the displacement of the light emitting point occurs in the second light source 64, it results only in the one-way displacement of the optical images of the green light LG and the red light LR, and there is no chance that the optical images overlapped with each other are displaced in the respective directions opposite to each other to thereby double the displacement amount. As described above, also in the projector 71 according to the present embodiment, the color shading in the projection image due to the temporal change can be reduced as much as possible.

It should be noted that the scope of the invention is not limited to the embodiments described above, but various modifications can be provided thereon within the scope or the spirit of the invention. For example, in the first embodiment, there is a description which reads as if the entire quantity of each of the colored lights comes from either one of the light sources such that the red light comes from the first light source formed of the red solid-state light source and the green light and the blue light come from the second light source formed of the white lamp. However, it is also possible that, for example, a minute proportion of the red light is included in the light emitted from the second light source while a large proportion of the red light is emitted from the first light source, and a minute proportion of the green light and the blue light is included in the light emitted from the first light source while a large proportion of the green light and the blue light is emitted from the second light source. In this case, although there is a possibility of slightly increasing the color shading compared to the case in which the entire quantity of each of the colored lights comes from either one of the light sources, a sufficient advantage can be obtained compared to the case in which the invention is not applied. Further, the specific configurations, the layout, the shape, the number, and so on of the optical elements of the projector are not limited to those of the embodiments described above, but can arbitrarily be modified. The combination of the colored lights emitted from the light sources can also be modified accordingly.

What is claimed is:

1. A projector comprising:
a first light source adapted to emit a light including a first colored light;
a second light source adapted to emit a light including a second colored light and a third colored light;
a color separation section to which the light emitted from the first light source and the light emitted from the second light source are input, the color separation section separating a lights input into the first colored light, the second colored light, and the third colored light;
a first light modulation element adapted to modulate the first colored light;
a second light modulation element adapted to modulate the second colored light;
a third light modulation element adapted to modulate the third colored light;
a light transmission section including a plurality of optical elements disposed between the color separation section and the first light modulation element;
a color combining section adapted to combine the first colored light modulated by the first light modulation element,the second colored light modulated by the second light modulation element, and the third colored light modulated by the third light modulation element; and
a projection section adapted to project a light combined by the color combining section on a projection target surface.

2. The projector according to claim 1, wherein
a light distribution of the light emitted from the first light source is narrower than a light distribution of the light emitted from the second light source.

3. A projector comprising:
a first light source adapted to emit a light including a first colored light;
a second light source adapted to emit a light including a second colored light and a third colored light;
a color separation section to which the light emitted from the first light source and the light emitted from the second light source are input, the color separation section separating a light input into the first colored light, the second colored light, and the third colored light;
a first light modulation element adapted to modulate the first colored light;
a second light modulation element adapted to modulate the second colored light;
a third light modulation element adapted to modulate the third colored light;
a first light transmission section including a plurality of optical elements disposed between the color separation section and the second light modulation element;
a second light transmission section including a plurality of optical elements disposed between the color separation section and the third light modulation element;
a color combining section adapted to combine the first colored light modulated by the first light modulation element,the second colored light modulated by the second light modulation element, and the third colored light modulated by the third light modulation element; and
a projection section adapted to project the light combined by the color combining section on a projection target surface.

4. The projector according to claim 1, wherein
the first light source is a laser source, and
the second light source is a phosphor adapted to emit the light including the second colored light and the third colored light using the light including the first colored light emitted from the laser source as an excitation light.

5. The projector according to claim 4, wherein
the light emitted from the first light source and including the first colored light is a blue light,
the light emitted from the second light source and including the second colored light and the third colored light is a yellow light, and
the phosphor transmits a part of the blue light emitted from the first light source.

6. The projector according to claim 4, wherein
the phosphor is formed of a phosphor layer formed on one surface of a plate member arranged to be rotatable.
